(19) United States
(12) Patent Application Publication
(10) Pub. No.: US 2026/0276165 A1
(43) Pub. Date: Sep. 17, 2026

(54) VEHICLE LAMP ILLUMINATION MODULE AND VEHICLE LAMP

(71) Applicant: Hasco Vision Technology Co., Ltd., Shanghai (CN)

(72) Inventors: Jie Zhang, Shanghai (CN); Shikun Dong, Shanghai (CN); Jiayuan Chen, Shanghai (CN); Hao Zhou, Shanghai (CN); Cong Li, Shanghai (CN)

(21) Appl. No.: 19/168,787

(22) PCT Filed: Jul. 14, 2023
(86) PCT No.: PCT/CN2023/107531

§ 371 Date: Sep. 24, 2025

(51) Int. Cl. F21S 41/365; F21S 41/148; F21S 41/151; F21S 41/32; F21V 7/06; F21V 7/08; F21W 102/14; F21Y 107/50

(52) U.S. Cl. CPC F21S 41/365; F21S 41/148; F21S 41/151; F21S 41/321; F21V 7/06; F21V 7/08; F21W 2102/14; F21Y 2107/50

(57) ABSTRACT

A vehicle lamp illumination module and a vehicle lamp are provided. The vehicle lamp illumination module includes a circuit board, a light source arranged on the circuit board, and a reflective mirror and an optical lens arranged in sequence in the direction of light path transmission, light emitted from the light source is reflected by the reflective mirror and is then projected through the optical lens to form an illumination light pattern; the light source includes a first light source and a second light source which have the same light emission direction; the reflective mirror includes a first reflecting surface corresponding to the first light source and a second reflecting surface corresponding to the second light source; the optical lens includes a first optical lens corresponding to the first reflecting surface and a second optical lens corresponding to the second reflecting surface.

### TECHNICAL FIELD

The present disclosure relates to a technical field of vehicle lamps, and in particular to a vehicle lamp illumination module and a vehicle lamp.

### BACKGROUND

With the development of society and the economy, the automotive industry has also evolved, placing greater demands on the functionality of vehicle lamps. Illumination devices that implement vehicle lamp illumination functions typically incorporate vehicle lamp illumination modules to achieve various light emitting patterns and achieve better illumination effects.

Existing vehicle lamp illumination modules typically include a low-beam light source circuit board; a low-beam reflective mirror and a low-beam optical lens provided sequentially along a low-beam light path transmission direction and a high-beam light source circuit board; and a high-beam reflective mirror and a high-beam optical lens provided sequentially along a high-beam light path transmission direction. Achieving low-beam light pattern requires a light-to-dark cutoff line structure provided at a boundary of the low-beam reflective mirror, followed by imaging through the low-beam optical lens. While existing methods can achieve either high-beam or low-beam light patterns, these vehicle lamp illumination modules require numerous components and a large number of format molds, resulting in complex manufacturing and assembly processes. Product performance is susceptible to component manufacturing and assembly errors, resulting in significant performance fluctuations and poor manufacturing consistency.

### SUMMARY

The present disclosure addresses the shortcomings of the prior art by providing a vehicle lamp illumination module that achieves high-beam or low-beam light pattern output while reducing the number of components and reducing assembly difficulty.

Another object of the present disclosure is to provide a vehicle lamp with a reduced number of components, reducing assembly difficulty and improving manufacturing efficiency.

The embodiments of the present disclosure are implemented through the following technical solutions.

A vehicle lamp illumination module is provided, including: a circuit board; a light source provided on the circuit board; and a reflective mirror and an optical lens provided in sequence along a light path transmission direction, where light emitted by the light source is reflected by the reflective mirror and then projected through the optical lens to form an illumination light pattern; the light source includes a first light source and a second light source with a same light emitting direction, the reflective mirror includes a first reflecting surface corresponding to the first light source and a second reflecting surface corresponding to the second light source, and the optical lens includes a first optical lens corresponding to the first reflecting surface and a second optical lens corresponding to the second reflecting surface; and the first light source, the first reflecting surface, and the first optical lens form a first optical structure, where the first light source and the first reflecting surface are arranged along a first direction; the second light source, the second reflecting surface, and the second optical lens form a second optical structure, where the second light source and the second reflecting surface are arranged along the first direction, and the first reflecting surface and the second reflecting surface are arranged along a second direction, the first reflecting surface and the second reflecting surface are staggered in the first direction, where the first optical lens and the second optical lens are arranged along the first direction, and the first direction and the second direction form an angle. The vehicle lamp illumination module can achieve high-beam or low-beam light pattern outputs while reducing the number of components and assembly difficulty.

Further, the first reflecting surface has at least a first focal point, and the second reflecting surface has at least a third focal point, where the first light source is located at the first focal point; and the second light source is located at the third focal point.

Further, a cutoff line structure for forming a bright-dark cutoff line is provided on the first reflecting surface, and a focal point of the first optical lens is located on the cutoff line structure of the first reflecting surface; the first light source is located on a side of the first reflecting surface facing a direction of gravity, and the first optical structure is configured to form a low-beam light pattern; or the first light source is located on a side of the first reflecting surface away from the direction of gravity, and the first optical structure is configured to form a low-beam three-zone light pattern.

Further, a cutoff line structure for forming a bright-dark cutoff line is provided on the second reflecting surface, the focal point of the second optical lens is located on the cutoff line structure of the second reflecting surface;
the second light source is located on a side of the second reflecting surface facing a direction of gravity, and the second optical structure is configured to form a low-beam light pattern; or the second light source is located on a side of the second reflecting surface away from the direction of gravity, and the second optical structure is configured to form a low-beam three-zone light pattern.

Further, a focal point of the first optical lens is located on the first reflecting surface; the first light source is located on a side of the first reflecting surface facing a direction of gravity, and the first optical structure is configured to form a high-beam light pattern; or the first light source is located on a side of the first reflecting surface away from the direction of gravity, and the first optical structure is configured to form a high-beam light pattern.

Further, the focal point of the second optical lens is located on the second reflecting surface; the second light source is located on a side of the second reflecting surface facing a direction of gravity, and the second optical structure is configured to form a high-beam light pattern; or the second light source is located on a side of the second reflecting surface away from the direction of gravity, and the second optical structure is configured to form a high-beam light pattern.

Further, the first reflecting surface further has a second focal point, and a focal point of the first optical lens coincides with the second focal point; and/or the second reflecting surface further has a fourth focal point, and a focal point of the second optical lens coincides with the fourth focal point.

Further, the first optical structure further includes a first reflector, a boundary of the first reflector away from the first light source is located at the second focal point, and light reflected by the first reflecting surface passes from a side of the first reflector facing the first reflecting surface; the first light source is located on a side of the first reflecting surface facing a direction of gravity, and the first optical structure is configured to form a low-beam light pattern; or the first light source is located on a side of the first reflecting surface away from the direction of gravity, and the first optical structure is configured to form a low-beam three-zone light pattern.

Further, the second optical structure further includes a second reflector, a boundary of the second reflector away from the second light source is located at the fourth focal point, and light reflected by the second reflecting surface passes through a side of the second reflector facing the second reflecting surface; the second light source is located on a side of the second reflecting surface facing a direction of gravity, and the second optical structure is configured to form a low-beam light pattern; or the second light source is located on a side of the second reflecting surface away from the direction of gravity, and the second optical structure is configured to form a low-beam three-zone light pattern.

Further, the first light source is located on a side of the first reflecting surface facing a direction of gravity, and the first optical structure is configured to form a high-beam light pattern; or the first light source is located on a side of the first reflecting surface away from the direction of gravity, and the first optical structure is configured to form a high-beam light pattern.

Further, the first optical structure further includes a third reflector extending from the first reflecting surface away from the second reflecting surface, and light reflected by the first reflecting surface passes through a side of the third reflector facing the first light source.

Further, the second light source is located on a side of the second reflecting surface facing a direction of gravity, and the second optical structure is configured to form a high-beam light pattern; or the second light source is located on a side of the second reflecting surface away from the direction of gravity, and the second optical structure is configured to form a high-beam light pattern.

Further, the second optical structure further includes a fourth reflector extending from the second reflecting surface facing the first reflecting surface, and light reflected by the second reflecting surface passes from a side of the fourth reflector facing the second light source.

Further, when the first reflecting surface has only a first focus, the first reflecting surface is a parabolic or a quasi-parabolic surface; when the first reflecting surface has a first focus and a second focus, the first reflecting surface is an ellipsoidal or a quasi-ellipsoidal surface; and when the second reflecting surface has only a third focus, the second reflecting surface is a parabolic or a quasi-parabolic surface; when the second reflecting surface has a third focus and a fourth focus, the second reflecting surface is an ellipsoidal or a quasi-ellipsoidal surface.

Further, the first reflecting surface is located between the second reflecting surface and the optical lens, a light-transmitting structure is provided on the circuit board, the first light source and the second light source are located on both sides of the light-transmitting structure, and the first light source and the second light source are arranged along a third direction, wherein the third direction and the second direction form an angle to enable light reflected by the second reflecting surface to pass through the light-transmitting structure.

Further, the light-transmitting structure is a through hole or a groove.

Further, the light source further includes a third light source, and the reflective mirror further includes a third reflecting surface corresponding to the third light source; the third reflecting surface is located on a side of the second reflecting surface away from the first reflecting surface, and orthographic projections of the first reflecting surface, the second reflecting surface, and the third reflecting surface on the circuit board do not overlap; the third light source and the third reflecting surface form a third optical structure; and light emitted by the third light source is capable of being reflected by the third reflecting surface and then emitted to form an illumination light pattern.

Further, the third optical structure further includes a third light-transmitting element connected to a side of the second optical lens away from the first optical lens; and light emitted by the third light source is capable of being reflected by the third reflecting surface and then projected through the third light-transmitting element to form an illumination light pattern.

Further, the first reflecting surface has only a first focal point, and the second reflecting surface has only a third focal point. One of the first optical structure and the second optical structure forms a low-beam light pattern, and the other forms a high-beam light pattern. When the light source corresponding to the optical structure forming the high-beam light pattern is turned on, the light source corresponding to the optical structure forming the low-beam light pattern is at least partially turned off.

A vehicle lamp is provided, including the aforementioned vehicle lamp illumination module. The vehicle lamp has a relatively small number of components, which can reduce assembly difficulty and improve manufacturing efficiency.

The technical solution disclosed herein has at least the following advantages and beneficial effects.

The vehicle lamp illumination module provided in the embodiments of the present disclosure includes a circuit board; a light source provided on the circuit board; and a reflective mirror and an optical lens provided sequentially along a light path transmission direction. Light emitted by the light source is reflected by the reflective mirror and then projected through the optical lens to form an illumination light pattern. The light source includes a first light source and a second light source with a same light emitting direction. The reflective mirror includes a first reflecting surface corresponding to the first light source and a second reflecting surface corresponding to the second light source. The optical lens includes a first optical lens corresponding to the first reflecting surface and a second optical lens corresponding to the second reflecting surface. The first light source, the first reflecting surface, and the first optical lens form a first optical structure, where the first light source and the first reflecting surface are arranged along a first direction. The second light source, the second reflecting surface, and the second optical lens form a second optical structure, where the second light source and the second reflecting surface are arranged along the first direction, the first reflecting surface and the second reflecting surface are arranged along a second direction, and the first reflecting surface and the second reflecting surface are staggered in the first direction. The first optical lens and the second optical lens are arranged along the first direction, and the first and second directions form an angle. By providing the first and second light sources on the same circuit board, providing the first and second reflecting surfaces on the same reflective mirror, and providing the first and second optical lenses on the same optical lens, the present disclosure can reduce the number of components, thereby resolving the problem of assembly errors between multiple components to a certain extent, and reducing the assembly difficulty of the vehicle lamp illumination module and resolving the problem of the stability of the entire vehicle lamp illumination module. In addition, the present disclosure can save components in the illumination module and save costs by arranging the first optical structure and the second optical structure.

### BRIEF DESCRIPTION OF DRAWINGS

To more clearly illustrate the technical solutions of the embodiments of the present disclosure, the following briefly describes the drawings required for use in the embodiments. It should be understood that the following drawings illustrate only certain embodiments of the present disclosure and should not be construed as limiting the scope of the present disclosure. A person skilled in the art would be able to derive other drawings based on these drawings without inventive effort.

FIG. 1 is a first structural schematic diagram of a vehicle lamp illumination module provided in the embodiments of the present disclosure;

FIG. 2 is an exploded view of FIG. 1;

FIG. 3 is a light path diagram of FIG. 1;

FIG. 4 is a second structural schematic diagram of the vehicle lamp illumination module provided in the embodiments of the present disclosure;

FIG. 5 is a light path diagram of FIG. 4;

FIG. 6 is a third structural schematic diagram of the vehicle lamp illumination module provided in the embodiments of the present disclosure;

FIG. 7 is a fourth structural schematic diagram of the vehicle lamp illumination module provided in the embodiments of the present disclosure;

FIG. 8 is an exploded view of FIG. 7;

FIG. 9 is a light path diagram of FIG. 7;

FIG. 10 is a first structural schematic diagram of a reflective mirror provided in the embodiments of the present disclosure;

FIG. 11 is a second structural schematic diagram of the reflective mirror provided in the embodiments of the present disclosure;

FIG. 12 is a third structural schematic diagram of the reflective mirror provided in the embodiments of the present disclosure;

FIG. 13 is a fourth structural schematic diagram of the reflective mirror provided in the embodiments of the present disclosure.

FIG. 14 is a fifth structural schematic diagram of a vehicle lamp illumination module provided by an embodiment of the present disclosure;

FIG. 15 is a low-beam light pattern diagram of the vehicle lamp illumination module in FIG. 14;

FIG. 16 is a main low-beam light pattern diagram of one side of the vehicle lamp illumination module in FIG. 14;

FIG. 17 is a main low-beam light pattern diagram of the other side of the vehicle lamp illumination module in FIG. 14;

FIG. 18 is an auxiliary low-beam light pattern diagram of one side of the vehicle lamp illumination module in FIG. 14;

FIG. 19 is an auxiliary low-beam light pattern diagram of the other side of the vehicle lamp illumination module in FIG. 14;

FIG. 20 is a high-beam light pattern diagram of the vehicle lamp illumination module in FIG. 14;

FIG. 21 is a light pattern diagram of a vehicle lamp illumination module provided by the prior art when both high and low-beams are turned on;

FIG. 22 is a light pattern diagram of the vehicle lamp illumination module in FIG. 14 when both auxiliary low-beams and high-beams are turned on.

Reference signs: 10—circuit board; 11—through hole; 21—first light source; 22—second light source; 23—third light source; 30—reflective mirror; 31—first reflecting surface; 32—second reflecting surface; 33—third reflecting surface; 40—optical lens; 41—first optical lens; 42—second optical lens; 43—third light-transmitting element; 50—first reflector; 60—second reflector; 70—heat sink; 81—main low-beam light source; 82—auxiliary low-beam light source; 91—third reflector; 92—fourth reflector; a—first direction; b—second direction.

### DETAILED DESCRIPTION OF EMBODIMENTS

To further clarify the objectives, technical solutions, and advantages of the embodiments of the present disclosure, the technical solutions of the embodiments of the present disclosure will be described clearly and completely in combination with the drawings in the embodiments of the present disclosure below. Obviously, the described embodiments are only a portion of, and not all of the embodiments of the present disclosure. The components of the embodiments of the present disclosure, as generally described and illustrated in the drawings herein, can be provided and designed in a variety of different configurations.

Therefore, the following detailed description of the embodiments of the present disclosure, as provided in the drawings, is not intended to limit the scope of the claimed disclosure but rather merely represents selected embodiments of the present disclosure. It should be noted that, unless conflicting, the various features of the embodiments of the present disclosure can be combined, and the resulting combined embodiments remain within the scope of protection of the present disclosure.

In the description of the present disclosure, it should be noted that the terms “center”, “upper”, “lower”, “left”, “right”, etc., indicating orientations or positional relationships, are based on the orientations or positional relationships shown in the drawings, or are the orientations or positional relationships typically placed when the product in the disclosure is in use, and therefore should not be construed as limiting the present disclosure. Further, the terms “first”, “second”, “third”, etc., are used solely for distinction and should not be construed as indicating or implying relative importance.

It should also be noted that, unless otherwise specified or limited, the terms “provided” and “connected” should be understood broadly. For example, they can refer to direct connection, indirect connection through an intermediary medium, or internal connection between two components. Those ordinarily skilled in the art will understand the specific meanings of these terms in the present disclosure based on the specific circumstances.

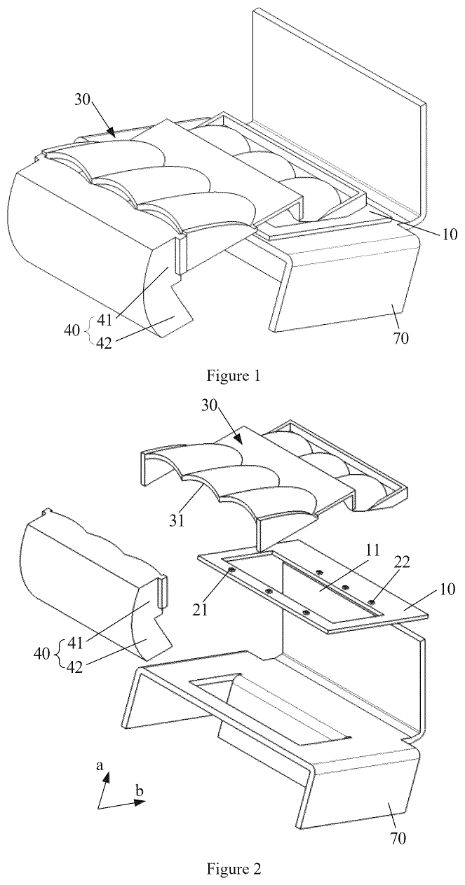

Please refer to FIGS. 1 to 3, the present disclosure provides a vehicle lamp illumination module, including a circuit board 10, a light source provided on the circuit board 10, and a reflective mirror 30 and an optical lens 40 provided in sequence along a light path transmission direction. The light emitted by the light source is reflected by the reflective mirror 30 and then projected through the optical lens 40 to form an illumination light shape. The light source includes a first light source 21 and a second light source 22 with the same light emitting direction (in each embodiment of the present disclosure, the same light emitting direction only refers to light emitting roughly facing the same side, and does not limit the light emitting optical axis directions of the first light source 21 and the second light source 22 to be exactly the same). The reflective mirror 30 includes a first reflecting surface 31 corresponding to the first light source 21 and a second reflecting surface 32 corresponding to the second light source 22, and the optical lens 40 includes a first optical lens 41 corresponding to the first reflecting surface 31 and a second optical lens 42 corresponding to the second reflecting surface 32. The first light source 21, the first reflecting surface 31, and the first optical lens 41 form a first optical structure. The first light source 21 and the first reflecting surface 31 are arranged along a first direction a. The second light source 22, the second reflecting surface 32, and the second optical lens 42 form a second optical structure. The second light source 22 and the second reflecting surface 32 are arranged along the first direction a, and the first reflecting surface 31 and the second reflecting surface 32 are arranged along a second direction b. The first reflecting surface 31 and the second reflecting surface 32 are staggered in the first direction a. The first optical lens 41 and the second optical lens 42 are arranged along the first direction a, and the first direction a and the second direction b form an angle. This vehicle lamp illumination module can achieve high-beam or low-beam light pattern output while reducing the number of components and reducing a difficulty of assembly. Specifically, the light sources of the first optical structure and the second optical structure can share a circuit board, thereby reducing the number of circuit boards and the heat dissipation structure.

As shown in FIG. 2, the vehicle lamp illumination module provided by the present disclosure includes a circuit board 10, a light source, a reflective mirror 30, and an optical lens 40. Light emitted by the light source, after being reflected by the reflective mirror 30, can incident on the optical lens 40, and after being projected by the optical lens 40, can form an illumination light pattern.

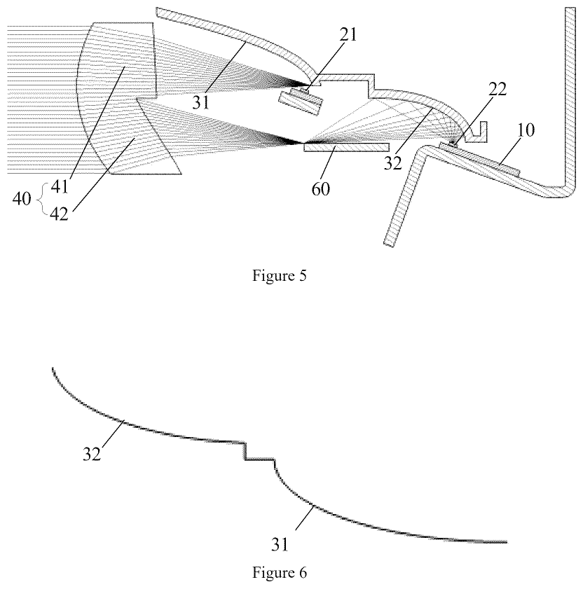

It should be noted that the light source includes a first light source 21 and a second light source 22. In the present disclosure, the first light source 21 and the second light source 22 have the same light emitting direction. For example, as shown in FIG. 2, the first light source 21 and the second light source 22 can both emit light upward, or as shown in FIG. 6, the first light source 21 and the second light source 22 can both emit light downward.

The first light source 21 and the second light source 22 are both provided on the same circuit board 10, as shown in FIG. 2. The circuit board 10 can control the first light source 21 and/or the second light source 22 to be turned on or off.

The reflective mirror 30 includes a first reflecting surface 31 and a second reflecting surface 32. In this embodiment, the first reflecting surface 31 and second reflecting surface 32 are both located on the reflective mirror 30. The first reflecting surface 31 corresponds to the first light source 21 and is configured to reflect light emitted by the first light source 21. The second reflecting surface 32 corresponds to the second light source 22 and is configured to reflect light emitted by the second light source 22.

In this embodiment, the first reflecting surface 31 and the second reflecting surface 32 are arranged along the second direction b (i.e., provided in a front-to-back arrangement as shown in FIG. 2) and are staggered in the first direction a (i.e., staggered in a top-to-bottom arrangement as shown in FIG. 2).

The first direction a and the second direction b are provided at an angle. For example, the angle between the first direction a and the second direction b can be 90°. The first direction a and the second direction b are merely configured to schematically illustrate the arrangement direction of the components and are not intended to be limited here. The angle between the first direction a and the second direction b can be provided as needed.

The optical lens 40 includes a first optical lens 41 and a second optical lens 42 arranged along the first direction a. In this embodiment, the first optical lens 41 and the second optical lens 42 are integrally formed. This reduces the number of components in the vehicle lamp illumination module and reduces the difficulty of assembly of the vehicle lamp illumination module.

The first optical lens 41 corresponds to the first reflecting surface 31. Light emitted by the first light source 21, after being reflected by the first reflecting surface 31, can incident on the first optical lens 41, and after being projected by the first optical lens 41, can form an illumination light pattern. Similarly, the second optical lens 42 corresponds to the second reflecting surface 32. Light emitted by the second light source 22, after being reflected by the second reflecting surface 32, can incident on the second optical lens 42, and after being projected by the second optical lens 42, can form an illumination light pattern.

In this embodiment, the first light source 21, the first reflecting surface 31, and the first optical lens 41 form a first optical structure, while the second light source 22, the second reflecting surface 32, and the second optical lens 42 form a second optical structure. It should be noted that the first optical structure can be configured to form either a low-beam or high-beam light pattern, and the second optical structure can also be configured to form either a low-beam or high-beam light pattern. The present disclosure does not limit the light patterns formed by the first optical structure and the second optical structure; the specific light patterns can be provided as needed.

To sum up, the vehicle lamp illumination module provided by the present disclosure includes a circuit board 10, a light source provided on the circuit board 10, and a reflective mirror 30 and an optical lens 40 provided in sequence along a light path transmission direction. The light emitted by the light source, after being reflected by the reflective mirror 30 and then being projected through the optical lens 40, forms an illumination light shape. The light source includes a first light source 21 and a second light source 22 with the same light emitting direction, the reflective mirror 30 includes a first reflecting surface 31 corresponding to the first light source 21 and a second reflecting surface 32 corresponding to the second light source 22, and the optical lens 40 includes a first optical lens 41 corresponding to the first reflecting surface 31 and a second optical lens 42 corresponding to the second reflecting surface 32. The first light source 21, the first reflecting surface 31, and the first optical lens 41 form a first optical structure. The first light source 21 and the first reflecting surface 31 are arranged along a first direction a. The second light source 22, the second reflecting surface 32, and the second optical lens 42 form a second optical structure. The second light source 22 and the second reflecting surface 32 are arranged along the first direction a. The first reflecting surface 31 and the second reflecting surface 32 are arranged along a second direction b. The first reflecting surface 31 and the second reflecting surface 32 are staggered in the first direction a. The first optical lens 41 and the second optical lens 42 are arranged along the first direction a, and the first direction a and the second direction b form an angle. By providing the first light source 21 and the second light source 22 on the same circuit board 10, providing the first reflecting surface 31 and the second reflecting surface 32 on the same reflective mirror 30, and providing the first optical lens 41 and the second optical lens 42 on the same optical lens 40, the present disclosure can reduce the number of components, thereby resolving the problem of assembly errors between multiple components to a certain extent, and reducing the assembly difficulty and overall stability of the vehicle lamp illumination module.

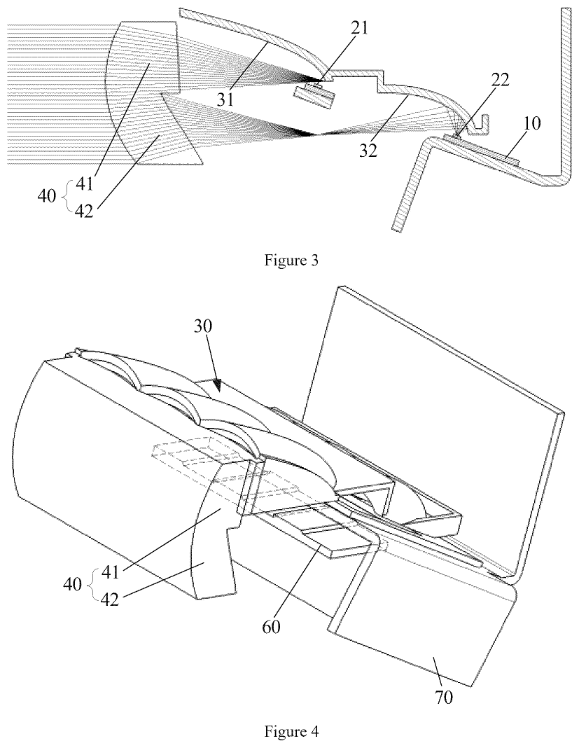

Referring again to FIG. 3 and FIG. 5, further, the above-mentioned first reflecting surface 31 has at least a first focal point, and the second reflecting surface 32 has at least a third focal point. The first light source 21 is located at the first focal point, and the second light source 22 is located at the third focal point.

That is, when the first reflecting surface 31 of the present disclosure has only a first focal point, the first optical structure can employ a single-focus optical system. The first light source 21 is provided at the focal point of the first reflecting surface 31 (i.e., the first focal point) or in an area near the focal point. The divergent light emitted by the first light source 21 is reflected by the first reflecting surface 31 and then strikes a light incident surface of the first optical lens 41 as a nearly parallel beam. After being projected by the first optical lens 41, it forms an illumination light pattern. It should be noted that the first light source 21 being provided at the first focal point refers to a position of the first light source 21 being provided at or near the first focal point (i.e., the first focal point does not necessarily refer to an absolute position of first focal point). This near position can be selected based on actual circumstances and is not further limited in the present disclosure.

When the second reflecting surface 32 has only a third focal point, the second optical structure can employ a single-focus optical system. The second light source 22 is provided at or near the third focal point. The divergent light emitted by the second light source 22 is reflected by the second reflecting surface 32 and then strikes the second optical lens 42 as a nearly parallel beam to image and form an illumination pattern. It should be noted that the second light source 22 being provided at the third focal point refers to a position of the second light source 22 at or near the third focal point (i.e., the third focal point does not necessarily refer to an absolute position of the third focal point). This near position can be selected based on actual circumstances and is not further limited in the present disclosure.

Of course, the above-described single-focus optical system for both the first optical structure and the second optical structure is merely an example. In other embodiments, the first optical structure and the second optical structure can also employ dual-focus optical systems. Specifically, one of the first optical structure and the second optical structure can employ a single-focus optical system and the other a dual-focus optical system; or both can employ single-focus optical systems; or both can employ dual-focus optical systems. The present disclosure does not limit these specific configurations.

When both the first optical structure and the second optical structure employ a single-focus optical system, the first optical structure can produce a low-beam light pattern, or the second optical structure can produce a low-beam light pattern; the first optical structure can produce a high-beam light pattern, or the second optical structure can produce a high-beam light pattern. Specifically, the present disclosure provides examples of the aforementioned situations as follows.

For example, in a first optional embodiment, a cutoff line structure for forming a bright-dark cutoff line is provided on the first reflecting surface 31, and the focal point of the first optical lens 41 is located on the cutoff line structure of the first reflecting surface 31. The first light source 21 is located on the side of the first reflecting surface 31 facing a direction of gravity, and the first optical structure is configured to produce a low-beam light pattern.

That is, in this embodiment, the reflective mirror 30 is mounted in an upright position (i.e., the first light source 21 is located on the side of the first reflecting surface 31 facing the direction of gravity, also referred to as the first light source 21 being located below the first reflecting surface 31). In this embodiment, the first optical structure can be configured to emit a low-beam light pattern.

Alternatively, a cutoff line structure for forming a bright-dark cutoff line is provided on the first reflecting surface 31, and the focal point of the first optical lens 41 is located on the cutoff line structure of the first reflecting surface 31. The first light source 21 is located on the side of the first reflecting surface 31 away from the direction of gravity, and the first optical structure is configured to form a three-zone low-beam light pattern. The present disclosure is not limited to this. When the first light source 21 is located on the side of the first reflecting surface 31 away from the direction of gravity, the first optical structure can also be configured to form other light patterns, such as a portion of a high-beam light pattern.

That is, in the above embodiment, the reflective mirror 30 is mounted in an inverted position (i.e., the first light source 21 is located on the side of the first reflecting surface 31 away from the direction of gravity, also referred to as the first light source 21 being located above the first reflecting surface 31). In this embodiment, when the cutoff line structure is provided on the first reflecting surface 31 and the focal point of the first optical lens 41 is located on the cutoff line structure of the first reflecting surface 31, the first optical structure can be configured to form a three-zone low-beam light pattern or other desired light pattern.

Further, the cutoff line structure can be provided at the boundary of the first reflecting surface 31, and the present disclosure is not limited to this.

It should be noted that in the first optional embodiment described above, the first optical structure is configured to produce a low-beam light pattern. Regardless of whether the first reflecting surface 31 is mounted in the inverted or upright position, the present disclosure does not limit a type of illumination pattern projected by the second optical structure. In other words, the second optical structure can be configured to produce either a low-beam or a high-beam light pattern.

In the second optional embodiment, a cutoff line structure is provided on the second reflecting surface 32 to form a bright-dark cutoff line. The focal point of the second optical lens 42 is located on the cutoff line structure of the second reflecting surface 32. The second light source 22 is located on the side of the second reflecting surface 32 facing the direction of gravity. The second optical structure is configured to produce a low-beam light pattern.

That is, in the above embodiment, the reflective mirror 30 is mounted in an upright position (i.e., the second light source 22 is located on the side of the second reflecting surface 32 facing the direction of gravity, also referred to as the second light source 22 being located below the second reflecting surface 32). In this configuration, the second optical structure can be configured to produce a low-beam light pattern.

Alternatively, a cutoff line structure for forming a bright-dark cutoff line is provided on the second reflecting surface 32, and the focal point of the second optical lens 42 is located on the cutoff line structure of the second reflecting surface 32. The second light source 22 is located on the side of the second reflecting surface 32 away from the direction of gravity, and the second optical structure is configured to form a three-zone low-beam light pattern. The present disclosure is not limited to this. When the second light source 22 is located on the side of the second reflecting surface 32 away from the direction of gravity, the first optical structure can also be configured to form other light patterns, such as a portion of a high-beam light pattern.

That is, in the above embodiment, the reflective mirror 30 is mounted in an inverted position (i.e., the second light source 22 is located on the side of the second reflecting surface 32 away from the direction of gravity, also referred to as the second light source 22 being located above the second reflecting surface 32). In this embodiment, when the cutoff line structure is provided on the second reflecting surface 32 and the focal point of the second optical lens 42 is located on the cutoff line structure of the second reflecting surface 32, the second optical structure can be configured to form a three-zone low-beam light pattern or other desired light pattern.

Further, the cutoff line structure can be provided at a boundary of the second reflecting surface 32, and the present disclosure is not limited to this.

It should be noted that in the second optional embodiment described above, the second optical structure is configured to form a low-beam light pattern. Regardless of whether the second reflecting surface 32 is mounted in the inverted or upright position, the present disclosure does not limit the type of illumination light pattern projected by the first optical structure. In other words, in this embodiment, the first optical structure can be configured to form either a low-beam light pattern or a high-beam light pattern.

In a third optional embodiment, the focal point of the first optical lens 41 is located on the first reflecting surface 31; the first light source 21 is located on the side of the first reflecting surface 31 facing the direction of gravity; and the first optical structure is configured to form a high-beam light pattern.

That is, in the above embodiment, the reflective mirror 30 is mounted in an upright position (i.e., the first light source 21 is located on the side of the first reflecting surface 31 facing the direction of gravity, also referred to as the first light source 21 being located below the first reflecting surface 31). In this configuration, the first optical structure can be configured to produce a high-beam light pattern.

Alternatively, the focal point of the first optical lens 41 is located on the first reflecting surface 31; the first light source 21 is located on the side of the first reflecting surface 31 away from the direction of gravity. The first optical structure can be configured to produce a high-beam light pattern.

That is, in the above embodiment, the reflective mirror 30 is mounted in the inverted position (i.e., the first light source 21 is located on the side of the first reflecting surface 31 away from the direction of gravity, also referred to as the first light source 21 being located above the first reflecting surface 31). In this embodiment, the focal point of the first optical lens 41 is located on the first reflecting surface 31. The first optical structure can be configured to produce a high-beam light pattern.

It should be noted that in the third optional embodiment described above, the first optical structure is configured to produce a high-beam light pattern. Regardless of whether the first reflecting surface 31 is mounted in the inverted or upright position, the present disclosure does not limit the type of illumination light pattern projected by the second optical structure. In other words, in this embodiment, the second optical structure can be configured to produce either a low-beam or a high-beam light pattern.

In a fourth optional embodiment, the focal point of the second optical lens 42 is located on the second reflecting surface 32; the second light source 22 is located on the side of the second reflecting surface 32 facing the direction of gravity, and the second optical structure is configured to form a high-beam light pattern.

That is, in the above embodiment, the reflective mirror 30 is mounted in the upright position (i.e., the second light source 22 is located on the side of the second reflecting surface 32 facing the direction of gravity, also referred to as the second light source 22 is located below the second reflecting surface 32). In this embodiment, the second optical structure can be configured to form a high-beam light pattern.

Alternatively, the focal point of the second optical lens 42 is located on the second reflecting surface 32; the second light source 22 is located on the side of the second reflecting surface 32 away from the direction of gravity. The second optical structure is configured to form a high-beam light pattern.

That is, in the above embodiment, the reflective mirror 30 is mounted in the inverted position (i.e., the second light source 22 is located on the side of the second reflecting surface 32 away from the direction of gravity, also referred to as the second light source 22 is located above the second reflecting surface 32). In this embodiment, the focal point of the second optical lens 42 is located on the second reflecting surface 32, and the second optical structure can be configured to form a high-beam light pattern.

It should be noted that in the fourth optional embodiment described above, the second optical structure is configured to form a high-beam light pattern. Regardless of whether the second reflecting surface 32 is mounted in the inverted or upright position, the present disclosure does not limit the type of illumination light pattern projected by the first optical structure. In other words, in this embodiment, the first optical structure can be configured to form either a low-beam or a high-beam light pattern.

Further, the first reflecting surface 31 can have a second focal point, where the focal point of the first optical lens 41 coincides with the second focal point; and/or the second reflecting surface 32 can have a fourth focal point, where the focal point of the second optical lens 42 coincides with the fourth focal point.

That is, at least one of the first optical structure and the second optical structure can be the dual-focus optical system. Alternatively, the first optical structure can be a dual-focus optical system; alternatively, the second optical structure can be a dual-focus optical system; or alternatively, both the first optical structure and the second optical structure can be dual-focus optical systems. In a dual-focus optical system, the reflecting surface does not have a focal point for the light source, but rather coincides with the focal point of the corresponding optical lens.

When at least one of the first optical structure and the second optical structure is the dual-focus optical system, the following situations are also contained.

Optionally, in the first situation, as shown in FIG. 10, the first optical structure further includes a first reflector 50. A boundary of the first reflector 50 away from the first light source 21 can be located at the second focal point (i.e., a left boundary of the first reflector 50 in FIG. 10 is located at the second focal point). Light reflected by the first reflecting surface 31 passes from a side of the first reflector 50 facing the first reflecting surface 31 (i.e., light reflected by the first reflecting surface 31 passes from above the first reflector 50). The first light source 21 is located on the side of the first reflecting surface 31 facing the direction of gravity. The first optical structure is configured to form a low-beam light pattern. In other embodiments, the first reflector 50 can be provided as needed without reference to the second focal point of the first reflecting surface 31.

That is, in the above embodiment, the reflective mirror 30 is mounted in the upright position (i.e., the first light source 21 is located on the side of the first reflecting surface 31 facing the direction of gravity, also referred to as the first light source 21 being located below the first reflecting surface 31). In this case, after the first reflector 50 is provided to the first optical structure, the first optical structure can be configured to form a low-beam light pattern.

In this configuration, the boundary of the first reflector 50 away from the first light source 21 is located at the second focal point, so that light reflected by the first reflecting surface 31 converges at the boundary of the first reflector 50 away from the first light source 21 and is scattered out toward the first optical lens 41. Further, a cutoff line structure can be formed at the boundary of the first reflector 50 away from the first light source 21, so that the low-beam light pattern formed by the first optical structure has a cutoff line corresponding to this cutoff line structure.

Alternatively, the first optical structure further includes a first reflector 50. A boundary of the first reflector 50 away from the first light source 21 is located at the second focal point. Light reflected by the first reflecting surface 31 passes from the side of the first reflector 50 facing the first reflecting surface 31. The first light source 21 is located on the side of the first reflecting surface 31 away from the direction of the gravity. The first optical structure is configured to produce a three-zone low-beam light pattern. The present disclosure is not limited to this. When the first light source 21 is located on the side of the first reflecting surface 31 away from the direction of the gravity, the first optical structure can also be configured to produce other light patterns, such as a portion of a high-beam light pattern.

That is, in the above embodiment, the reflective mirror 30 is mounted in the inverted position (i.e., the first light source 21 is located on the side of the first reflecting surface 31 away from the direction of the gravity, also referred to as the first light source 21 being located above the first reflecting surface 31). In this embodiment, when the first reflector 50 is provided to the first optical structure, the first optical structure can be configured to produce a three-zone low-beam light pattern or other desired light patterns.

It should be noted that in the first situation described above, the first optical structure employs a dual-focus optical system and is configured to form a low-beam light pattern. Regardless of whether the first reflecting surface 31 is mounted in the inverted or upright position, the present disclosure does not limit the type of optical system employed by the second optical structure (it can be either a single-focus or dual-focus optical system), nor does it limit the type of illumination light pattern projected by the second optical structure. In other words, in this embodiment, the second optical structure can be configured to form either a low-beam or a high-beam light pattern.

Alternatively, in the second situation, as shown in FIG. 11, the second optical structure further includes a second reflector 60. A boundary of the second reflector 60 away from the second light source 22 can be located at the fourth focal point (i.e., a left boundary of the second reflector 60 in FIG. 11 is located at the fourth focal point). Light reflected by the second reflecting surface 32 passes from the side of the second reflector 60 facing the second reflecting surface 32 (i.e., light reflected by the second reflecting surface 32 passes from above the second reflector 60). The second light source 22 is located on the side of the second reflecting surface 32 facing the direction of gravity, and the second optical structure is configured to produce a low-beam light pattern. In other embodiments, the second reflector 60 can be positioned as needed without reference to the fourth focal point of the second reflector 60.

That is, in the above embodiment, the reflective mirror 30 is mounted in the upright position (i.e., the second light source 22 is located on the side of the second reflecting surface 32 facing the direction of gravity, also referred to as the second light source 22 being located below the second reflecting surface 32). In this embodiment, after the second reflector 60 is provided to the second optical structure, the second optical structure can be configured to produce a low-beam light pattern.

In this embodiment, a boundary of the second reflector 60 away from the second light source 22 is located at the fourth focal point, so that light reflected by the second reflecting surface 32 converges at the boundary of the second reflector 60 away from the second light source 22 and is scattered out toward the second optical lens 42. Further, the boundary of the second reflector 60 away from the second light source 22 can form a cutoff line structure, so that the low-beam light pattern formed by the second optical structure has a cutoff line corresponding to this cutoff line structure.

Alternatively, the second optical structure further includes a second reflector 60, the boundary of the second reflector 60 away from the second light source 22 is located at the fourth focal point, and light reflected by the second reflecting surface 32 passes from the side of the second reflector 60 facing the second reflecting surface 32. The second light source 22 is located on the side of the second reflecting surface 32 away from the direction of gravity. The second optical structure is configured to form a three-zone low-beam light pattern. The present disclosure is not limited to this. When the second light source 22 is located on the side of the second reflecting surface 32 away from the direction of gravity, the second optical structure can also be configured to form other light patterns, such as a portion of a high-beam light pattern.

In the above embodiment, the reflective mirror 30 is mounted in the inverted position (i.e., the second light source 22 is located on the side of the second reflecting surface 32 away from the direction of gravity, also referred to as the second light source 22 being located above the second reflecting surface 32). In this embodiment, when the second optical structure is provided with the second reflector 60, the second optical structure can be configured to produce a three-zone low-beam light pattern or other desired light pattern.

It should be noted that in the second embodiment, the second optical structure employs a dual-focus optical system and is configured to produce a low-beam light pattern. Regardless of whether the second reflecting surface 32 is mounted in the inverted or upright position, the present disclosure does not limit the type of optical system employed by the first optical structure (it can be a single-focus optical system or a dual-focus optical system), nor does it limit the type of illumination light pattern projected by the first optical structure. In other words, in this embodiment, the first optical structure can be configured to produce either a low-beam or a high-beam light pattern.

Alternatively, in the third embodiment, the first light source 21 is located on the side of the first reflecting surface 31 facing the direction of gravity, and the first optical structure is configured to produce a high-beam light pattern.

That is, in the above embodiment, the reflective mirror 30 is mounted in the upright position (i.e., the first light source 21 is located on the side of the first reflecting surface 31 facing the direction of gravity, also referred to as the first light source 21 being located below the first reflecting surface 31). In this embodiment, the first optical structure can be configured to produce a high-beam light pattern.

Alternatively, the first light source 21 is located on the side of the first reflecting surface 31 away from the direction of gravity, and the first optical structure can be configured to produce a high-beam light pattern.

That is, in the above embodiment, the reflective mirror 30 is mounted in the inverted position (i.e., the first light source 21 is located on the side of the first reflecting surface 31 away from the direction of gravity, also referred to as the first light source 21 being located above the first reflecting surface 31). In this embodiment, the first optical structure can also be configured to produce a high-beam light pattern.

It should be noted that in the third situation described above, the first optical structure employs a dual-focus optical system and is configured to produce a high-beam light pattern. Regardless of whether the first reflecting surface 31 is mounted in the inverted or upright position, the present disclosure does not limit the type of optical system employed by the second optical structure (it can be a single-focus or dual-focus optical system), nor does it limit the type of illumination light pattern projected by the second optical structure. In other words, the second optical structure can be configured to produce either a low-beam or a high-beam light pattern.

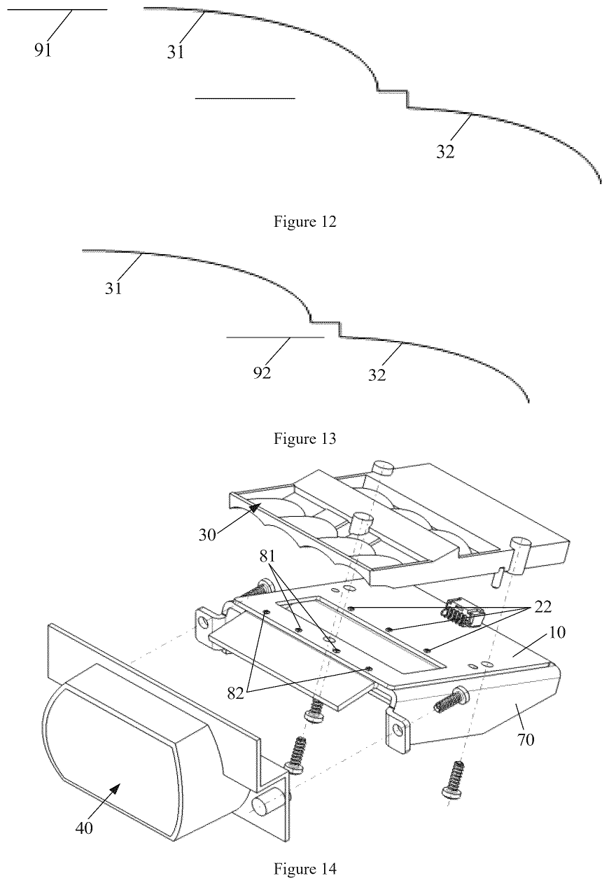

Optionally, in the first or third situation described above, referring to FIG. 12, the first optical structure can further include a third reflector 91. The third reflector 91 extends from the first reflecting surface 31 away from the second reflecting surface 32. Light reflected by the first reflecting surface 31 passes from the side of the third reflector 91 facing the first light source 21.

That is, after the third reflector 91 provided on the side of the first reflecting surface 31 of the first optical structure away from the second reflecting surface 32, light reflected by the first reflecting surface 31 can pass underneath the third reflector 91. The third reflector 91 can be independent from the first reflecting surface 31 or integrally formed with the reflective mirror 30. Stray light emitted by the first reflecting surface 31 is reflected by the third reflector 91, thereby an angle and gradient of the lower boundary of the light pattern can be controlled by the third reflector 91. The provision of third reflector 91 is particularly suitable for controlling the angle and gradient of the lower boundary of the high-beam light pattern.

Alternatively, in a fourth situation, the second light source 22 is located on the side of the second reflecting surface 32 facing the direction of gravity, and the second optical structure is configured to form the high-beam light pattern.

That is, in the above embodiment, the reflective mirror 30 is mounted in the upright position (i.e., the second light source 22 is located on the side of the second reflecting surface 32 facing the direction of gravity, also referred to as the second light source 22 being located below the second reflecting surface 32). In this embodiment, the first optical structure can be configured to form the high-beam light pattern.

Alternatively, the second light source 22 is located on the side of the second reflecting surface 32 away from the direction of gravity, and the second optical structure is configured to form the high-beam light pattern.

In the above embodiment, the reflective mirror 30 is mounted in the inverted position (i.e., the second light source 22 is located on the side of the second reflecting surface 32 away from the direction of gravity, also referred to as the second light source 22 being located above the second reflecting surface 32). In this embodiment, the second optical structure can be configured to produce a high-beam light pattern.

It should be noted that in the fourth situation described above, the second optical structure employs a single-focus optical system, and the second optical structure is configured to produce a high-beam light pattern. Regardless of whether the second reflecting surface 32 is mounted in the inverted or upright position, the present disclosure does not limit the type of optical system employed by the first optical structure (it can be a single-focus optical system or a dual-focus optical system), nor does it limit the type of illumination light pattern projected by the first optical structure. In other words, in this embodiment, the first optical structure can be configured to produce either a low-beam or a high-beam light pattern.

Optionally, in the second or fourth situation described above, as shown in FIG. 13, the second optical structure can further include a fourth reflector 92. The fourth reflector 92 extends from the second reflecting surface 32 toward the first reflecting surface 31. Light reflected by the second reflecting surface 32 passes through a side of the fourth reflector 92 that faces the second light source 22.

That is, after providing the fourth reflector 92 on a side of the second reflecting surface 32 of the second optical structure closing to the first reflecting surface 31, light reflected by the second reflecting surface 32 can pass underneath the fourth reflector 92. The fourth reflector 92 can be independent from the second reflecting surface 32 or integrally formed with the reflective mirror 30. Stray light emitted from the second reflecting surface 32 is reflected by the fourth reflector 92, thereby the angle and gradient of the lower boundary of the light pattern can be controlled by the fourth reflector 92. The provision of the fourth reflector 92 is particularly suitable for controlling the angle and gradient of the lower boundary of the high-beam light pattern.

Further, when the first reflecting surface 31 has only a first focus, the first reflecting surface 31 can be a parabolic or a quasi-parabolic surface; and when the first reflecting surface 31 has a first and a second focus, the first reflecting surface 31 can be an ellipsoidal or a quasi-ellipsoidal surface.

When the second reflecting surface 32 has only a third focus, the second reflecting surface 32 can be a parabolic or a quasi-parabolic surface; and when the second reflecting surface 32 has a third and a fourth focus, the second reflecting surface 32 can be an ellipsoidal or a quasi-ellipsoidal surface.

Further, in this embodiment, optionally, as shown in FIG. 3 and FIG. 5, the first reflecting surface 31 is located between the second reflecting surface 32 and the optical lens 40. A light-transmitting structure is provided on the circuit board 10. The first light source 21 and the second light source 22 are located on either side of the light-transmitting structure. The first light source 21 and the second light source 22 are provided along a third direction. The third direction forms an angle with the second direction b, such that light reflected by the second reflecting surface 32 can pass through the light-transmitting structure.

The third direction can be provided at an angle to the second direction b, and a structure between the first light source 21 and the second light source 22 is the light-transmitting structure. In this way, the light emitted by the first optical structure and the second optical structure do not affect each other.

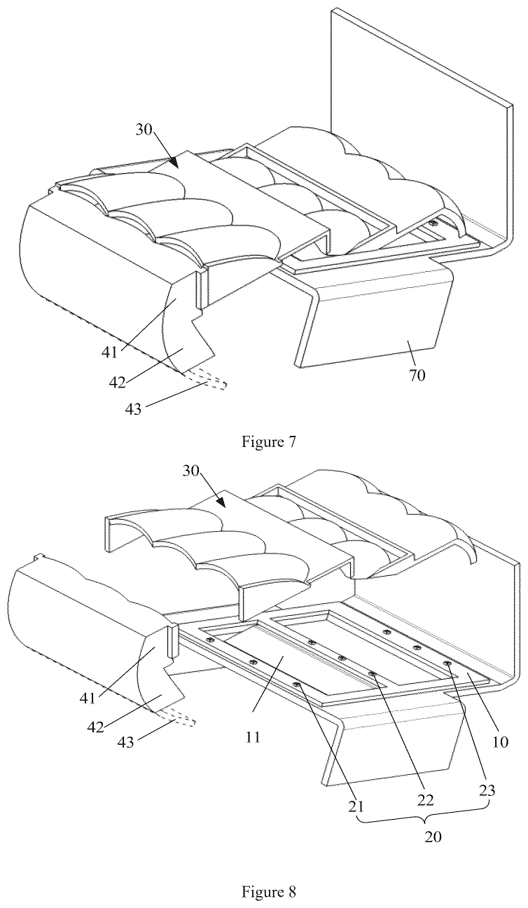

Optionally, the light-transmitting structure is a through hole 11 or a groove. As shown in FIG. 2 and FIG. 8.

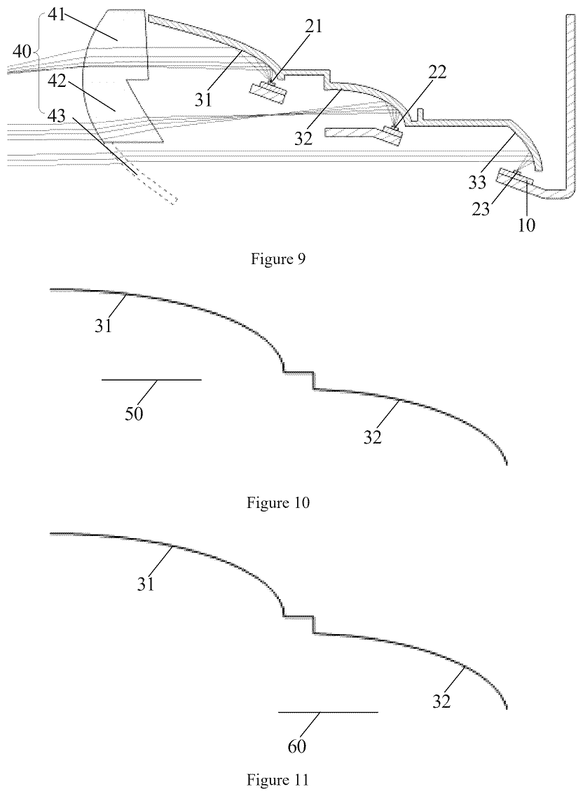

Please refer to FIG. 7 to FIG. 9, optionally, the light source described above can include a third light source 23, and the reflective mirror 30 can include a third reflecting surface 33 corresponding to the third light source 23. The third reflecting surface 33 is located on the side of the second reflecting surface 32 away from the first reflecting surface 31, and the orthographic projections of the first reflecting surface 31, the second reflecting surface 32, and the third reflecting surface 33 on the circuit board 10 do not overlap. The third light source 23 and the third reflecting surface 33 form a third optical structure. Light emitted by the third light source 23 can be reflected by the third reflecting surface 33 and then emitted to form an illumination light pattern.

That is, in addition to the first optical structure and the second optical structure described above, the present disclosure can also include a third optical structure, which includes the third light source 23 and the third reflecting surface 33. Through the provision of the multi-layer module configuration, the present disclosure can meet different user application requirements. The third optical structure can directly form an illumination light pattern.

Alternatively, as shown in FIG. 8, the third optical structure can further include a third light-transmitting element 43. The third light-transmitting element 43 is connected to the side of the second optical lens 42 away from the first optical lens 41, or can be directly integrally formed with the optical lens. Light emitted by the third light source 23 can be reflected by the third reflecting surface 33 and then projected through the third light-transmitting element 43 to form an illumination light pattern.

That is, in addition to the third optical structure being able to directly form an illumination light pattern, a third light-transmitting element 43 (which can be a transparent structure of equal wall thickness) can also be provided in the light path of light emitting of the third optical structure. The provision of the third light-transmitting element 43 should not affect the light patterns of the first optical structure and the second optical structure. Further, in some variations, the third optical structure can have the same structure as the first or second optical structure. The present disclosure is not intended to be limited here, and arrangements with multiple optical layers are also within the scope of protection of the present disclosure.

In addition, in this embodiment, the vehicle lamp illumination module described above can further include a heat sink 70 provided on the side of the circuit board 10 away from the lens. The heat sink 70 is configured to dissipate heat from the vehicle lamp illumination module. The present disclosure does not limit the shape of the heat sink 70. To reduce the number of components and assembly difficulty, the heat sink 70 should include heat dissipation components for the first optical structure and the second optical structure (and, when a third optical structure is included, also for the third optical structure) respectively. In other words, the heat sink 70 is an integral heat sink, capable of dissipating heat for the entire vehicle lamp illumination module.

For example, referring to FIG. 14, assume that the first optical structure is configured to produce a low-beam light pattern, and the second optical structure is configured to generate a high-beam light pattern. In this case, the first light source 21 can include a main low-beam light source 81 and an auxiliary low-beam light source 82. The first reflecting surface 31 includes a first sub-reflective area and a second sub-reflective area. The first optical lens 41 includes a first sub-lens area and a second sub-lens area. Light emitted from the main low-beam light source 81 is reflected by the first sub-reflective area and then projected through the first sub-lens area to form a main low-beam light pattern with an inflection point. Light emitted by the auxiliary low-beam light source 82 is reflected by the second sub-reflective area and then projected through the second sub-lens area to form a horizontal auxiliary low-beam light pattern. Light emitted by the second light source 22 is reflected by the second reflecting surface 32 and then projected through the second optical lens 42 to form an illumination light pattern. The illumination light pattern and the auxiliary low-beam light pattern are superimposed to form a high-beam light pattern, and the main low-beam light pattern and the auxiliary low-beam light pattern are superimposed to form a low-beam light pattern.

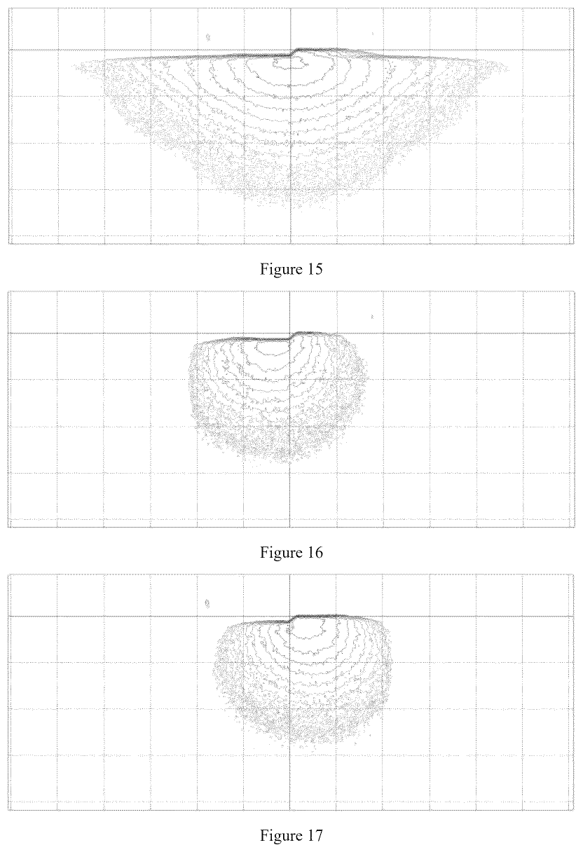

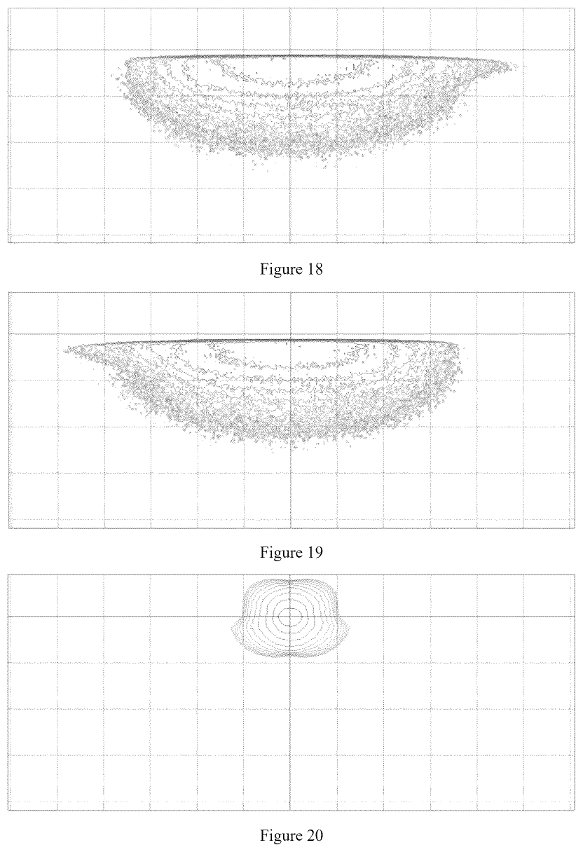

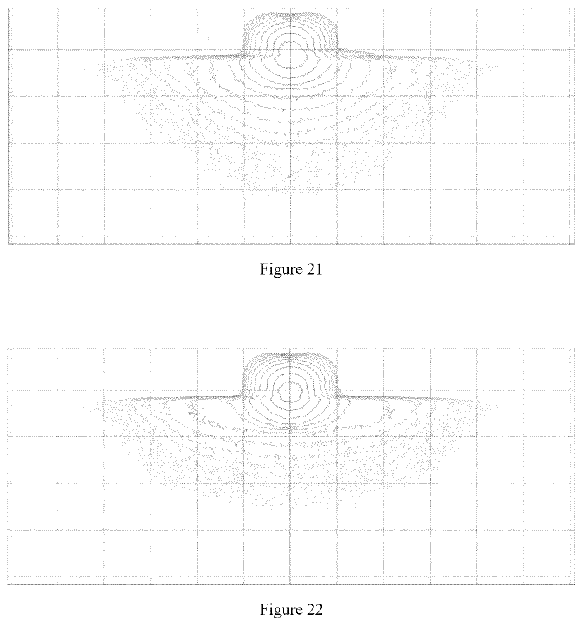

Please refer to FIG. 15 to FIG. 22. FIG. 15 shows the low-beam light pattern of the vehicle lamp illumination module. FIG. 16 and FIG. 17 are the light patterns obtained from the optical paths corresponding to the two main low-beam light sources 81 respectively, and FIG. 18 and FIG. 19 are the light patterns obtained from the optical paths corresponding to the two auxiliary low-beam light sources 82. FIG. 20 shows the corresponding high-beam light pattern of the vehicle lamp illumination module when it is operating as a high-beam light source. FIG. 21 shows a light pattern of a vehicle lamp illumination module provided by the prior art when both high-beam and low-beam are turned on. FIG. 22 shows the high-beam light pattern of the auxiliary low-beam light sources 82 and the high-beam light source in the above-mentioned embodiment provided by the present disclosure. It can be seen that a quality of the light pattern obtained by the embodiment provided by the present disclosure is significantly superior to the quality of the light pattern obtained by the existing low-beam and high-beam light sources when both are turned on.

The vehicle lamp illumination module provided by the present disclosure can achieve one or more of the following functions: high and low beam, main high beam, main low beam, auxiliary high beam, auxiliary low beam, supplemental high beam (e.g., enhanced high-beam brightness), supplemental low beam (brightness or width), and other signal light functions, but the present disclosure is not limited thereto.

The present disclosure also provides a vehicle lamp including the aforementioned vehicle lamp illumination module. This vehicle lamp has a relatively small number of components, which reduces assembly difficulty and improves manufacturing efficiency. The specific structure and beneficial effects of the aforementioned vehicle lamp illumination module have been described in detail previously and will not be further elaborated upon in the present disclosure.

### INDUSTRIAL APPLICABILITY

The vehicle lamp illumination module provided by the present disclosure can reduce the number of components, thereby solving the problem of assembly errors between multiple components to a certain extent, and reducing the assembly difficulty of the vehicle lamp illumination module and resolving the problem of the stability of the entire vehicle lamp illumination module. This vehicle lamp illumination module is applicable to various fields such as automobiles, motorcycles, bicycles, vessels, and the like.

1. A vehicle lamp illumination module, comprising:
a circuit board;
a light source provided on the circuit board; and
a reflective mirror and an optical lens provided in sequence along a light path transmission direction, wherein:
light emitted by the light source is reflected by the reflective mirror and then projected through the optical lens to form an illumination light pattern, the light source comprises a first light source and a second light source with a same light emitting direction, the reflective mirror comprises a first reflecting surface corresponding to the first light source and a second reflecting surface corresponding to the second light source, and the optical lens comprises a first optical lens corresponding to the first reflecting surface and a second optical lens corresponding to the second reflecting surface;
the first light source, the first reflecting surface, and the first optical lens form a first optical structure, wherein the first light source and the first reflecting surface are arranged along a first direction; and
the second light source, the second reflecting surface, and the second optical lens form a second optical structure, wherein the second light source and the second reflecting surface are arranged along the first direction, the first reflecting surface and the second reflecting surface are arranged along a second direction, and the first reflecting surface and the second reflecting surface are staggered in the first direction, and wherein the first optical lens and the second optical lens are arranged along the first direction, and the first direction and the second direction form an angle.

2. The vehicle lamp illumination module according to claim 1, wherein the first reflecting surface has at least a first focal point, and the second reflecting surface has at least a third focal point, and wherein the first light source is located at the first focal point, and the second light source is located at the third focal point.

3. The vehicle lamp illumination module according to claim 2, wherein a cutoff line structure for forming a bright-dark cutoff line is provided on the first reflecting surface, and a focal point of the first optical lens is located on the cutoff line structure of the first reflecting surface, and wherein:
the first light source is located on a side of the first reflecting surface facing a direction of gravity, and the first optical structure is configured to form a low-beam light pattern; or
the first light source is located on a side of the first reflecting surface away from the direction of gravity, and the first optical structure is configured to form a low-beam three-zone light pattern.

4. The vehicle lamp illumination module according to claim 2, wherein a cutoff line structure for forming a bright-dark cutoff line is provided on the second reflecting surface, and a focal point of the second optical lens is located on the cutoff line structure of the second reflecting surface, and wherein:
the second light source is located on a side of the second reflecting surface facing a direction of gravity, and the second optical structure is configured to form a low-beam light pattern; or
the second light source is located on a side of the second reflecting surface away from the direction of gravity, and the second optical structure is configured to form a low-beam three-zone light pattern.

5. The vehicle lamp illumination module according to claim 2, wherein a focal point of the first optical lens is located on the first reflecting surface, and wherein:
the first light source is located on a side of the first reflecting surface facing a direction of gravity, and the first optical structure is configured to form a high-beam light pattern; or
the first light source is located on a side of the first reflecting surface away from the direction of gravity, and the first optical structure is configured to form a high-beam light pattern.

6. The vehicle lamp illumination module according to claim 2, wherein a focal point of the second optical lens is located on the second reflecting surface, and wherein:
the second light source is located on a side of the second reflecting surface facing a direction of gravity, and the second optical structure is configured to form a high-beam light pattern; or
the second light source is located on a side of the second reflecting surface away from the direction of gravity, and the second optical structure is configured to form a high-beam light pattern.

7. The vehicle lamp illumination module according to claim 2, wherein:
the first reflecting surface further has a second focal point, and a focal point of the first optical lens coincides with the second focal point; and/or
the second reflecting surface further has a fourth focal point, and a focal point of the second optical lens coincides with the fourth focal point.

8. The vehicle lamp illumination module according to claim 7, wherein the first optical structure further comprises a first reflector, a boundary of the first reflector away from the first light source is located at the second focal point, and light reflected by the first reflecting surface passes from a side of the first reflector facing the first reflecting surface, and wherein:
the first light source is located on a side of the first reflecting surface facing a direction of gravity, and the first optical structure is configured to form a low-beam light pattern; or
the first light source is located on a side of the first reflecting surface away from the direction of gravity, and the first optical structure is configured to form a low-beam three-zone light pattern.

9. The vehicle lamp illumination module according to claim 7, wherein the second optical structure further comprises a second reflector, a boundary of the second reflector away from the second light source is located at the fourth focal point, and light reflected by the second reflecting surface passes from a side of the second reflector facing the second reflecting surface, and wherein:
the second light source is located on a side of the second reflecting surface facing a direction of gravity, and the second optical structure is configured to form a low-beam light pattern; or
the second light source is located on a side of the second reflecting surface away from the direction of gravity, and the second optical structure is configured to form a low-beam three-zone light pattern.

10. The vehicle lamp illumination module according to claim 7, wherein:
the first light source is located on a side of the first reflecting surface facing a direction of gravity, and the first optical structure is configured to form a high-beam light pattern; or
the first light source is located on a side of the first reflecting surface away from the direction of gravity, and the first optical structure is configured to form a high-beam light pattern.

11. The vehicle lamp illumination module according to claim 8, wherein the first optical structure further comprises a third reflector extending from the first reflecting surface away from the second reflecting surface, and wherein light reflected by the first reflecting surface passes through a side of the third reflector facing the first light source.

12. The vehicle lamp illumination module according to claim 7, wherein:
the second light source is located on a side of the second reflecting surface facing a direction of gravity, and the second optical structure is configured to form a high-beam light pattern; or
the second light source is located on a side of the second reflecting surface away from the direction of gravity, and the second optical structure is configured to form a high-beam light pattern.

13. The vehicle lamp illumination module according to claim 9, wherein the second optical structure further comprises a fourth reflector extending from the second reflecting surface facing the first reflecting surface, and wherein light reflected by the second reflecting surface passes through a side of the fourth reflector facing the second light source.

14. The vehicle lamp illumination module according to claim 2, wherein:
when the first reflecting surface has only a first focus, the first reflecting surface is a parabolic or a quasi-parabolic surface;
when the first reflecting surface has a first focus and a second focus, the first reflecting surface is an ellipsoidal or a quasi-ellipsoidal surface;
when the second reflecting surface has only a third focus, the second reflecting surface is a parabolic or a quasi-parabolic surface; and
when the second reflecting surface has a third focus and a fourth focus, the second reflecting surface is an ellipsoidal or a quasi-ellipsoidal surface.

15. The vehicle lamp illumination module according to claim 1, wherein the first reflecting surface is located between the second reflecting surface and the optical lens, a light-transmitting structure is provided on the circuit board, the first light source and the second light source are located on both sides of the light-transmitting structure, and the first light source and the second light source are arranged along a third direction, wherein the third direction and the second direction form an angle to enable light reflected by the second reflecting surface to pass through the light-transmitting structure.

16. The vehicle lamp illumination module according to claim 15, wherein the light-transmitting structure is a through hole or a groove.

17. The vehicle lamp illumination module according to claim 1, wherein:
the light source further comprises a third light source, and the reflective mirror further comprises a third reflecting surface corresponding to the third light source;
the third reflecting surface is located on a side of the second reflecting surface away from the first reflecting surface, and orthographic projections of the first reflecting surface, the second reflecting surface, and the third reflecting surface on the circuit board do not overlap;
the third light source and the third reflecting surface form a third optical structure; and
light emitted by the third light source is capable of being reflected by the third reflecting surface and then emitted to form an illumination light pattern.

18. The vehicle lamp illumination module according to claim 17, wherein:
the third optical structure further comprises a third light-transmitting element connected to a side of the second optical lens away from the first optical lens; and
light emitted by the third light source is capable of being reflected by the third reflecting surface and then projected through the third light-transmitting element to form an illumination light pattern.

19. A vehicle lamp comprising the vehicle lamp illumination module according to claim 1.

20. The vehicle lamp illumination module according to claim 10, wherein the first optical structure further comprises a third reflector extending from the first reflecting surface away from the second reflecting surface, and wherein light reflected by the first reflecting surface passes through a side of the third reflector facing the first light source.
